(19) United States
(12) Patent Application Publication
(10) Pub. No.: US 2025/0250441 A1
(43) Pub. Date: Aug. 7, 2025

(54) ECOFRIENDLY NANOCOMPOSITES FOR PORTABLE WATER PURIFICATION

(71) Applicant: TEXAS STATE UNIVERSITY, San Marcos, TX (US)

(72) Inventors: Sujata Mandal, San Marcos, TX (US); Sangchul Hwang, San Marcos, TX (US)

(73) Assignee: TEXAS STATE UNIVERSITY, San Marcos, TX (US)

(21) Appl. No.: 19/042,995

(22) Filed: Jan. 31, 2025

Related U.S. Application Data
(60) Provisional application No. 63/548,978, filed on Feb. 2, 2024.

(51) Int. Cl. C09C 1/56; C02F 1/00; C02F 1/28

(52) U.S. Cl. CPC C09C 1/56; C02F 1/002; C02F 1/283; C01P 2002/84; C01P 2002/85; C01P 2004/03

(57) ABSTRACT

The present disclosure pertains to a composite material that includes a biochar and metal particles embedded with the biochar. The biochar may include an acid-treated and pyrolyzed biochar derived from organic feedstock. The metal particles may include silver nanoparticles. The present disclosure also pertains to methods of purifying a liquid by applying the liquid to a composite material of the present disclosure such that the composite material retains impurities from the liquid. The present disclosure also pertains to methods of forming the composite materials.

### CROSS-REFERENCE TO RELATED APPLICATIONS

This application claims priority to U.S. Provisional Patent Application No. 63/548,978, filed on Feb. 2, 2024. The entirety of the aforementioned application is incorporated herein by reference.

### BACKGROUND

A need exists for more effective systems and methods of purifying various liquids. Numerous embodiments of the present disclosure aim to address the aforementioned need.

### SUMMARY

In some embodiments, the present disclosure pertains to a composite material that includes a biochar and metal particles embedded with the biochar. In some embodiments, the biochar includes an acid-treated and pyrolyzed biochar derived from organic feedstock. In some embodiments, the metal particles include silver nanoparticles. In some embodiments, the composite material is a component of a liquid filtration unit. In some embodiments, the liquid filtration unit is in the form of a column that includes: a clay-based layer; a filter back flush control layer below the clay-based layer; the composite material below the filter back flush control layer; and a fabric-based layer below the composite material.

Additional embodiments of the present disclosure pertain to methods of purifying a liquid by applying the liquid to a composite material of the present disclosure. In some embodiments, the composite material retains one or more impurities from the liquid. In some embodiments, the liquid purification methods of the present disclosure also include a step of recovering the impurities from the composite material.

Additional embodiments of the present disclosure pertain to methods of forming the composite materials of the present disclosure. In some embodiments, such methods include: (1) treating a biochar precursor with an acid; (2) pyrolyzing the biochar precursor to obtain biochar; and (3) mixing the biochar with metal particles.

### FIGURES

FIG. 1 provides a schematic diagram of a method of making a composite of the present disclosure.

FIG. 2 provides an exploded view of a multilayer filtering unit that includes a composite of the present disclosure.

FIG. 3A illustrates the fabrication of biochar-based silver nanoparticles (AgNPs), which was confirmed visually by changes in color.

FIG. 3B shows the ultraviolet visible (UV-VIS) spectrum of biochar-based AgNPs.

FIGS. 4A-4D show scanning electron microscopy (SEM) images of raw biomass (FIG. 4A), and acid-treated and pyrolyzed biochar at 200× magnification (FIG. 4B) and 700× magnification (FIG. 4C). FIG. 4D shows an SEM and an energy dispersive X-ray spectroscopy (EDAX) of biochar-based silver nanocomposites showing the successful encapsulation of AgNPs on the surface of biochar.

FIGS. 5A-5D show the purification of crystal violet and phenol by the composites of the present disclosure. FIG. 5A provides an image of methylene blue. FIG. 5B provides an image of crystal violet (CV). FIG. 5C provides UV-VIS spectra of CV before and after adsorption. FIG. 5D provides a UV-VIS spectra of phenol before and after adsorption.

FIG. 6 provides data demonstrating the enhanced antibacterial activities of biochar-based AgNPs against E. coli.

### DETAILED DESCRIPTION

It is to be understood that both the foregoing general description and the following detailed description are illustrative and explanatory, and are not restrictive of the subject matter, as claimed. In this application, the use of the singular includes the plural, the word “a” or “an” means “at least one”, and the use of “of” means “and/or”, unless specifically stated otherwise. Furthermore, the use of the term “including”, as well as other forms, such as “includes” and “included”, is not limiting. Also, terms such as “element” or “component” encompass both elements or components that includes one unit and elements or components that include more than one unit unless specifically stated otherwise.

The section headings used herein are for organizational purposes and are not to be construed as limiting the subject matter described. All documents, or portions of documents, cited in this application, including, but not limited to, patents, patent applications, articles, books, and treatises, are hereby expressly incorporated herein by reference in their entirety for any purpose. In the event that one or more of the incorporated literature and similar materials define a term in a manner that contradicts the definition of that term in this application, this application controls.

A need exists for more effective systems and methods of purifying various liquids, such as water. In particular, a need exists for more effective systems and methods of purifying water during times of emergency.

Wastewater and surface waters are typically unfit for human consumption or use as they contain a variety of pollutants, including organic materials (C, H, O, N), inorganic materials (Na, K, Ca, Mg, Cd, Cu, Pb, Ni, Zn), nutrients (NO₃, PO₄), pathogenic microorganisms (viruses, parasites, bacteria), hydrocarbons, endocrine disruptors, and other materials. According to the 2003 U N World Water Development Report, two million tons of sewage, industrial, and agricultural waste are discharged into the world's water daily. Other causes of water pollution and contamination include flooding, storms, tsunamis, earthquakes, hurricanes, and natural disasters, which can contaminate drinking water wells, cause aquifer contamination, and impact sanitation infrastructure (e.g., loss of power).

Commercial water treatment and purification technologies include a variety of processes depending on the volume and type of water to be treated and the types of impurity and contaminant to be removed. These techniques can be used as standalone processes. Membrane filtration is the most widely applied technique and encompasses four types of separation processes: microfiltration (MF), ultra-filtration (UF), reverse osmosis (RO), and nanofiltration (NF), which all rely on the use of hydraulic pressure to achieve separation.

The main difference in these membrane filtration processes, apart from pressure requirements, is membrane pore sizes. NF10 membrane material is typically constructed of polymers with pore sizes of less than 2 nm and is used to remove multivalent ions and charged particles from feed streams. MF11 systems have pore sizes of about 0.1-10 um and have primary application in separating large particles: colloids, particulates, fat, and bacteria. UF12 technology utilizes a semi-permeable, low-pressure membrane with pore sizes of 0.1-0.001 microns to physically remove suspended particles, bacteria, colloidal matter, and proteins of sizes ranging from less than 0.01-0.1 mm.

UF membranes cannot remove dissolved ions (Na, Ca, magnesium chloride, sulfate). RO13 is known for its efficiency in separating small particles, including bacteria and monovalent ions like sodium and chloride, which can remove up to 99.5% of these materials. RO13 has been widely used in wastewater treatment and desalination operations for many years. MF, UF, and NF techniques are often used as a pretreatment step in RO operations to reduce fouling of the RO membrane and to enhance the maintenance of constant flux.

Pressure-driven membrane processes have proved to be an effective technology for water reclamation operations from wastewater. However, they require significant amounts of energy to generate the required pressure differentials. Interest in membrane distillation (MD) has received attention in recent years as an alternative to traditional pressure-driven membrane filtration practices to ameliorate the high energy costs of these techniques. MD uses heat to separate substances based on their volatilities. Water vapor is transported across a hydrophobic microporous membrane based on the vapor pressure gradient across the membrane. This heat-driven process is beneficial for separating feed solutions and typically uses low-grade thermal energy (<100° C.) to provide the needed vapor pressure difference between the feed side and the product side of the membrane.

MD has found various applications, including use in seawater and brackish desalination, process water treatment, water purification, and ammonium removal. There are four main configurations used in MD: direct contact membrane distillation (DCMD), air-gap membrane distillation (AGMD), sweeping gas membrane distillation (SGMD), and vacuum membrane distillation (VMD), with the most commonly employed technology being DCMD.

Membrane materials used in the various MD applications are all hydrophobic and are typically constructed of PTFE, PP, or PVDF. As compared to pressure-driven membrane techniques (RO, NF, UF, MF), MD has many advantages. In particular, MD can be driven by renewable energy sources (e.g., solar, wind) or waste heat recovered from industrial processes, it requires lower hydrostatic pressure as compared to RO, it can be performed at near atmospheric pressure, and MD membrane fouling is less due to their larger pore sizes.

Disadvantages of MD include that it is a developing technique with uncertainties in water production costs. Moreover, surfactants or amphiphilic contaminants can result in membrane wetting, and the technique often results in low permeate flux.

A variety of membrane modification strategies have been developed to improve membrane performance, provide for selective analyte retention, and improve antifouling characteristics. Such strategies include chemical and physical surface modification techniques, such as coating, chemical grafting (e.g., thermal and/or plasma grafting), blending solutions using fillers, and polymerization.

Though these techniques are effective, they also have various drawbacks, including the use of toxic solvents, complex pretreatment steps, long processing times, and the need to use large volumes of particles and materials for modification purposes. Removal of toxic heavy metal ions is performed through a variety of techniques, including chemical precipitation, ion exchange, coagulation and flocculation, complexation, biosorption, adsorption, and membrane processes. Most of these processes require continuous input of chemicals, are expensive, and result in incomplete metal removal.

The two most commonly employed techniques are adsorption and ion exchange. Adsorption is an effective process for various applications, is considered economical, and is widely used.

The most generally used solid adsorbent material for metal ion removal from wastewater is activated carbon (AC). AC is a black, solid, powdered, granular, microcrystalline or pelletized nongraphitic form of carbon with a high porosity, a large internal surface area (500-1500/2500 m²/g), and a high capacity to bind contaminants. AC can physically adsorb gases or vapors and dissolved or dispersed substances from liquids. AC is produced by carbonization, pyrolysis, and thermal heating of carbonaceous source materials, such as coconuts, nutshells, coal, peat, wood, lignite, or any organic material with a high carbon content. AC removes heavy metals by complexation or electrostatic attraction of metal ions to various surface oxygen-containing functional groups. AC has limitations regarding metal removal from water because it tends to adsorb a range of metallic materials and does not selectively bind or remove specific heavy metal ions.

Ion exchange operates by exchanging ions between the substrate and surrounding medium (e.g., water). Ion exchange is one of the most widely applied techniques for treating metal-contaminated wastewater. Ion exchange resins are usable at different pH values, can be used at high temperatures, are environmentally friendly, can process large volumes of aqueous feedstock, and tend to have low maintenance costs. Disadvantages of ion exchange techniques include membrane fouling (e.g., calcium sulfate, and iron), organic matter adsorption, and membrane contamination.

Biochar is a stable solid, rich in carbon, made from organic waste material (e.g., agricultural waste) or biomass partially combusted in the presence of limited O₂ through pyrolysis. Biochar is a porous material that can help retain water and nutrients in the soil for the plants to take up as they grow. Due to their adsorption ability, some biochar has the potential to sequester heavy metals, pesticides, herbicides, and hormones, prevent nitrate leaching and fecal bacteria from entering into waterways, and reduce GHG emissions from soils.

In addition to reducing soil emissions of GHG, biochar is used in regenerative agriculture to improve soil quality, increase livestock feed productivity, and for water filtration treatments. Biochar technology offers a promising solution to mitigate climate change by reducing contamination and storing carbon in a cleaner and more efficient form.

Various water treatment and purification products are used to filter and clean water for consumption. These purifiers and filters can remove, kill, or inactivate a variety of pathogens from water, including bacteria and viruses, and can remove particulate matter (PM). Many of these filters and purifiers operate on the same mechanical principle (e.g., gravity) but may require the addition of chemicals (e.g., Iodine) to operate effectively and/or an electrostatic charge to bind and remove impurities from the water. These devices are well suited for home use but are not economical in large, industrial settings, for portable use as required during a natural disaster, or in remote military settings.

Options for obtaining purified water post-natural disaster or remote battlefield location include the transfer/distribution of bottled water to a location (e.g., FEMA shipments), purifying water through boiling to kill organisms, the addition of chlorine bleach to kill some disease-causing organisms, homemade filtration devices (e.g., AC and cloth/coffee filter), or the use of ultraviolet light to kill viruses or bacteria. Depending on the situation, equipment availability, and the skill of the individual, some of these techniques may not be feasible to use in an emergency setting.

As such, a need exists for more effective systems and methods of purifying liquids, such as water. In particular, a need exists for more effective systems and methods for accessing drinkable water in emergency situations, such as natural disasters. A need also exists for more eco-friendly, multipollutant, less energy-intensive, and fast water pollution mitigation technologies to remove the disadvantages of commercial filters. Numerous embodiments of the present disclosure aim to address the aforementioned limitations.

In some embodiments, the present disclosure pertains to a composite material that includes a biochar and metal particles embedded with the biochar. In further embodiments, the present disclosure pertains to methods of purifying a liquid by applying the liquid to a composite material of the present disclosure. Additional embodiments of the present disclosure pertain to methods of forming the composite materials of the present disclosure.

As set forth in more detail herein, the composite materials of the present disclosure can have numerous structures and compositions. Additionally, the liquid purification and composite formation methods of the present disclosure can have numerous embodiments.

### Biochars

The composite materials of the present disclosure may include various types of biochars. Additionally, the composite formation methods of the present disclosure may form various types of biochars. Moreover, the liquid purification methods of the present disclosure may utilize composite materials with various biochars.

For instance, in some embodiments, the biochar includes an acid-treated and pyrolyzed biochar. In some embodiments, the biochar includes organic acid-treated biochar. In some embodiments, the organic acid includes, without limitation, lactic acid, acetic acid, formic acid, citric acid, oxalic acid, uric acid, malic acid, tartaric acid, butyric acid, folic acid, or combinations thereof.

In some embodiments, the biochar is derived from organic feedstock. In some embodiments, the organic feedstock includes, without limitation, plant-based feedstocks, agro-based feedstocks, vegetable-based feedstocks, fruit-based feedstocks, waste-based feedstocks, wood-based feedstocks, fruit pit, or combinations thereof. In some embodiments, the organic feedstock includes fruit pit.

In some embodiments, the biochars of the present disclosure include carboxylic acid groups on their surfaces. In some embodiments, the metal particles are associated with the carboxylic acid groups.

In some embodiments, the composites of the present disclosure exhibit anti-bacterial properties. In some embodiments, such anti-bacterial properties may be suitable for disinfecting liquids during purification.

### Metal Particles

The composite materials of the present disclosure may include various metal particles. Additionally, the composite formation methods of the present disclosure may mix various metal particles with biochars. Moreover, the liquid purification methods of the present disclosure may utilize composite materials with various metal particles.

For instance, in some embodiments, the metal particles include, without limitation, silver, iron, zinc, aluminum, or combinations thereof. In some embodiments, the metal particles include silver. In some embodiments, the metal particles are in the form of nanoparticles, such as silver nanoparticles. In some embodiments, the nanoparticles have diameters ranging from about 1 nm to about 1000 nm. In some embodiments, the nanoparticles have diameters ranging from about 1 nm to about 500 nm. In some embodiments, the nanoparticles have diameters ranging from about 50 nm to about 400 nm. In some embodiments, the nanoparticles have diameters ranging from about 150 nm to about 300 nm. In some embodiments, the nanoparticles have diameters ranging from about 63 nm to about 381 nm.

### Composite Material Forms and Properties

The composite materials of the present disclosure may be in various forms. For instance, in some embodiments, the composite material is a component of a liquid filtration unit. In some embodiments, the liquid filtration unit is in the form of a column. In some embodiments, the column includes: a clay-based layer; a filter back flush control layer below the clay-based layer; the composite material below the filter back flush control layer; and a fabric-based layer (e.g., cotton layer) below the composite material.

The composite materials of the present disclosure can have various advantageous properties. For instance, in some embodiments, the composite material is biodegradable.

### Methods of Purifying a Liquid

Additional embodiments of the present disclosure pertain to methods of purifying a liquid by applying the liquid to a composite material of the present disclosure. In some embodiments, the composite material retains one or more impurities from the liquid.

In some embodiments, the liquid purification methods of the present disclosure also include a step of recovering the impurities from the composite material. In some embodiments, impurity recovery includes eluting the impurities from the composite material.

Various methods may be utilized to apply a liquid to a composite material of the present disclosure. For instance, in some embodiments, the application includes filtration of the liquid through the composite material. In some embodiments, the filtration includes gravity based filtration without the utilization of pumps. In some embodiments, the application includes incubation of the liquid with the composite material.

The liquid purification methods of the present disclosure may be utilized to purify various liquids. For instance, in some embodiments, the liquid includes water. In some embodiment, the water includes contaminated water that is contaminated with various impurities.

The liquid purification methods of the present disclosure may be utilized to retain various impurities from a liquid. In some embodiments, the methods of the present disclosure may also be utilized to recover various impurities. For instance, in some embodiments, the impurities include pollutants. In some embodiments, the pollutants include, without limitation, herbicides, hormones, organic pollutants, dyes, pathogenic organisms, agricultural materials, pesticides, pharmaceutical materials, hydrocarbons, inorganic contaminants, heavy metals, copper, lead, manganese, nickel, cobalt, or combinations thereof.

The liquid purification methods of the present disclosure may have various advantageous properties. For instance, in some embodiments, the liquid purification methods of the present disclosure may be utilized to capture impurities within 30 minutes of applying the liquid to a composite of the present disclosure. In some embodiments, the liquid purification methods of the present disclosure capture at least 90% of the impurity from the liquid. In some embodiments, the liquid purification methods of the present disclosure capture at least 95% of the impurity from the liquid. In some embodiments, the liquid purification methods of the present disclosure capture at least 98% of the impurity from the liquid. In some embodiments, the liquid purification methods of the present disclosure capture at least 99% of the impurity from the liquid.

### Methods of Forming Composite Materials

Additional embodiments of the present disclosure pertain to methods of forming the composite materials of the present disclosure. In some embodiments, such methods include: (1) treating a biochar precursor with an acid; (2) pyrolyzing the biochar precursor to obtain biochar; and (3) mixing the biochar with metal particles.

The methods of the present disclosure may treat various biochar precursors with an acid. For instance, in some embodiments, the biochar precursor includes organic feedstock. In some embodiments, the organic feedstock includes, without limitation, plant-based feedstocks, agro-based feedstocks, vegetable-based feedstocks, fruit-based feedstocks, waste-based feedstocks, wood-based feedstocks, fruit pit, or combinations thereof. In some embodiments, the biochar precursor includes fruit seed waste. In some embodiments, the biochar precursor includes woody tree seed waste.

The biochar precursors of the present disclosure may be treated with various acids in various manners. For instance, in some embodiments, the biochar precursors of the present disclosure may be treated with organic acids. Organic acids, which are products of amino acid catabolism and intermediates in various metabolic pathways, offer a sustainable and eco-friendly acid alternative due to their biological origin. This makes them a green material for enhancing the properties of biochar. In some embodiments, the organic acids include, without limitation, lactic acid, acetic acid, formic acid, citric acid, oxalic acid, uric acid, malic acid, tartaric acid, butyric acid, folic acid, or combinations thereof.

In some embodiments, acid treatment includes treatment in 10-20% (v/v) acid, such as organic acid. In some embodiments, the treatment of biochar precursors with organic acids grafts specific functional groups, such as carboxylic acid (—COOH) groups, onto the surface of the biochar precursor and the formed biochar. In some embodiments, such functionalization primarily occurs on a biochar's surface. In some embodiments, the surface characteristics of biochars are altered by such functionalization by modifying the functional groups present. In some embodiments, the acid treatment occurs at temperatures ranging from about 30° C. to about 40° C. In some embodiments, the acid treatment occurs for about 6 hours.

The biochar precursors of the present disclosure may be pyrolyzed in various manners. For instance, in some embodiments, the pyrolysis occurs in the absence of air or oxygen at temperatures of at least 500° C. In some embodiment, the pyrolysis occurs at 500° C. for 2 hours with a heating rate of 10° C./min.

The biochars of the present disclosure may be mixed with metal particles in various manners. For instance, in some embodiments, the mixing includes stirring.

### Applications and Advantages

The composites and liquid filtration methods of the present disclosure can have numerous advantages. For instance, in some embodiments, the composites of the present disclosure are 100% biodegradable with low carbon emission. Additionally, the composites and liquid filtration methods of the present disclosure provide efficient, fast, energy efficient, sustainable, portable, and cost-effective methods of purifying various liquids, such as water. Moreover, the composites and liquid filtration methods of the present disclosure can be utilized to filter liquids through natural forces of gravity for the purification of various liquids, such as contaminated water.

As such, the composites and liquid filtration methods of the present disclosure can be utilized for various applications. For instance, in some embodiments, the composites and liquid filtration methods of the present disclosure can be utilized to convert different biowastes into value added products, which can contribute effectively to environmental waste management systems. In some embodiments, the composites and liquid filtration methods of the present disclosure can be utilized to provide an uninterrupted source of safe water during various scenarios, such as emergencies or disasters. In some embodiments, the composites and liquid filtration methods of the present disclosure can be utilized to recover impurities, such as copper, lead, manganese, nickel, and cobalt.

The composite formation methods of the present disclosure also provide numerous advantages. For instance, in some embodiments, the composite formation methods of the present disclosure produce more stable association of metal particles with biochars than existing methods. Additionally, the composite formation methods of the present disclosure provide a facile and portable method of forming biochars.

### Additional Embodiments

Reference will now be made to more specific embodiments of the present disclosure and experimental results that provide support for such embodiments. However, Applicant notes that the disclosure herein is for illustrative purposes only and is not intended to limit the scope of the claimed subject matter in any way.

### Example 1. Fabrication of Nanocomposites for Water Purification

An objective of this Example was to effectively overcome the problems of commercial filters by providing a novel filter technology that is sustainable, multifunctional, conveniently portable, and saves time for assembling. The filter material can be used for water purification, especially during periods of emergency (e.g., winter storms, floods, and/or earthquakes) and military operations in extreme environmental conditions.

Diverse biomass materials have been explored as biosorbents (e.g., activated carbon and/or biochar) for water treatment due to their natural abundance. Recently, biochar has been examined as a prospective substitute for activated carbon in the remediation of emerging contaminants due to its low cost, relative abundance, and comparative remediation abilities.

Biochar is a solid residue obtained by the pyrolysis of biomass. Biochar is a benign and highly effective adsorbent material. Evidence shows that biochar and its activated derivatives can remove various contaminants, including pathogenic organisms. Due to the availability of biomass waste at low or zero cost and the necessity to protect the environment from pollution caused by the accumulation of these biowastes, much attention has been garnered for their utilization in wastewater treatment.

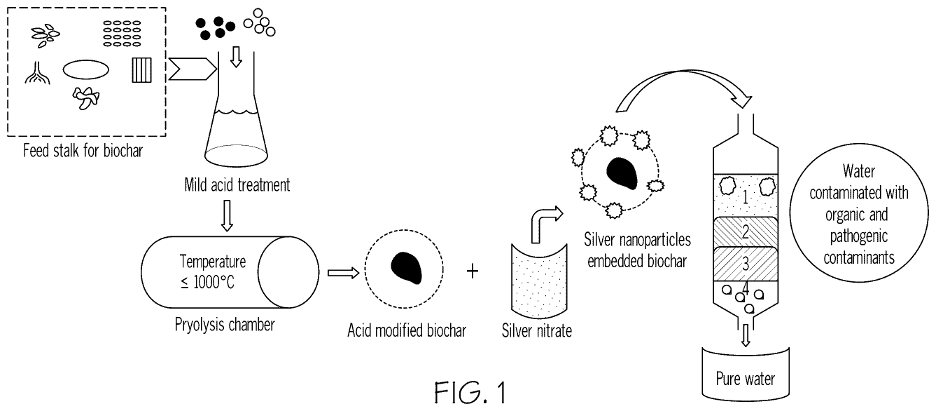

Most biochar is derived from various feedstocks, such as plant-based, agro-based, and vegetable and fruit waste-based feedstocks. As illustrated in FIG. 1, this Example describes the fabrication of a modified novel composite filter material using biochar-embedded silver nanoparticles, which the biochar is extracted from fruit seed wastes and woody tree seed waste. The filter material can be utilized for the improved exclusion of dyes, pesticides, pathogens, organic contaminants, and other pollutants from wastewater.

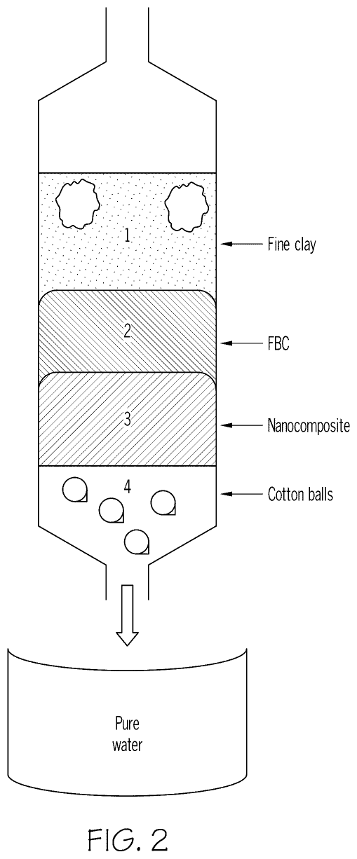

FIG. 2 provides a depiction of a fabricated multilayer filtering unit with fine clay 1; filter back flush control (FBC) 2; a nanocomposite 3 of this Example; and cotton balls 4. Raw biomass materials, fruit seed (e.g., apricot and avocado) and woody biomass seed wastes were collected and washed repeatedly in deionized water and sundried. The biomass were then soaked in 10%-20% v/v organic or mild acidic solutions for 6 hours at 200-300 rpm under 30-40° C. Citric acid, tartaric acid, and acetic acid can be used for modification of biochar. The mixture was washed several times and then filtrated through a 0.45-μm filter paper. The functionalized biosorbent was again dried in an oven at around 50° C. for 5-6 hours. This acid-modified biomass (AMB) was pyrolyzed in a tube furnace in the absence of air or oxygen at 500° C. for 2 hours with a heating rate of 10° C./min. The functionalized biochar (FBC) was mortared, sieved, and kept in an airtight container.

To evaluate the performance of the FBC for the remediation of industrial dyes and aromatic hydrocarbon, a preliminary biosorption experiment was conducted. Crystal violet (CV) and Methylene blue (MB) were chosen as two model industrial dyes and phenol as an aromatic hydrocarbon. 250 mL of each dye and phenol was taken in a round-bottomed flask and 0.5 g each of FBC was added to the dye solutions and shaken (200-300 rpm) for 30 minutes at 20±5° C. The pH of the solution was kept at ˜6.5. UV-Vis spectrophotometer was used for the adsorption studies of the two tested dye and phenol solutions.

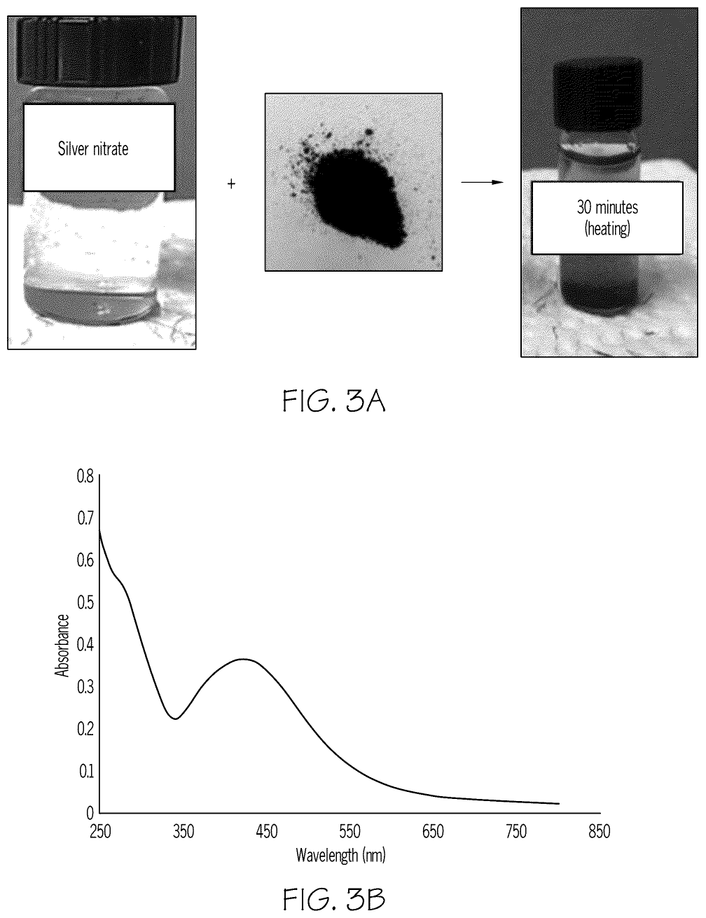

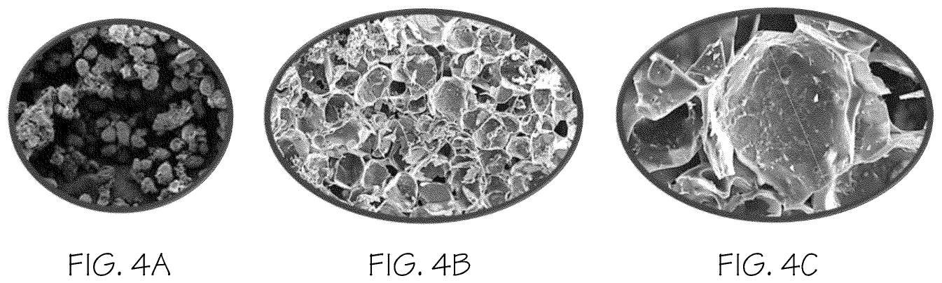

Applicant's next objective was the synthesis of a nanocomposite using functionalized biochar. Silver is an optimal disinfectant and has caused no harm to human health. Silver nanoparticles can penetrate bacterial cells and destroy the cell. Silver nanoparticles (AgNPs) were embedded in FBC using silver nitrate solution (FIGS. 3A-3B).

### Example 1.1. Experimental Results

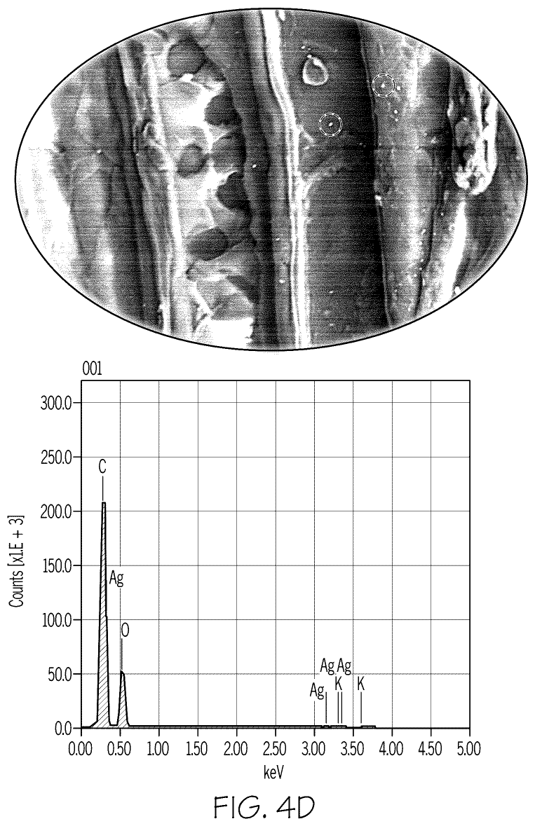

The surface morphologies of the raw biomass and biochar were investigated using scanning electron microscopy (SEM) analysis. The results are shown in FIGS. 4A-4D. The surface of raw biomass shown in FIG. 4A was dense, uneven, and rough. As shown in FIGS. 4B and 4C, after the pyrolysis, multiple pores were exhibited on the FBC surface, as expected.

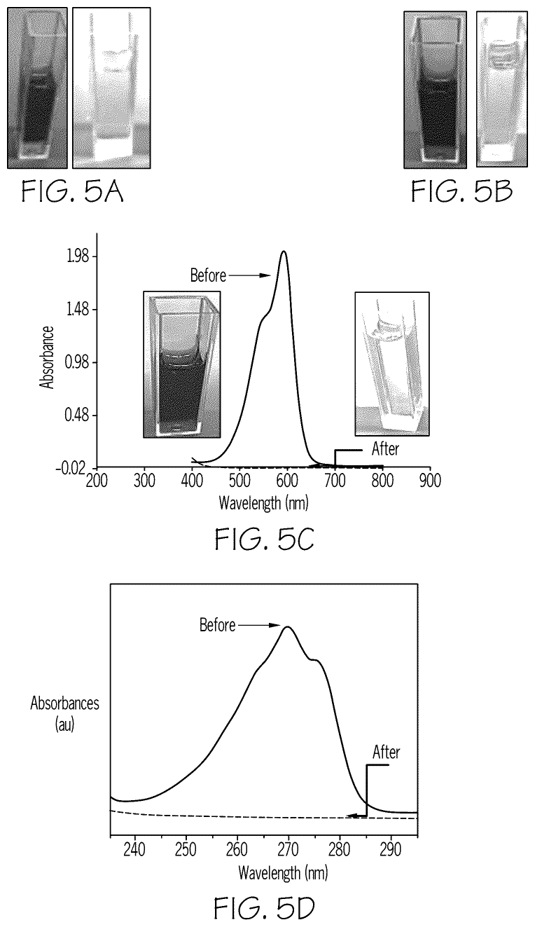

FIGS. 5A-5B demonstrate the color changes of MB and CV before and after adsorption using FBC. The concentration of the residual dyes and phenols were measured using UV-Vis spectrometry (FIG. 5C). Based on an adsorption study (30 min), the removal rate of CV and MB by FBC was 99.9% and 90.5%, respectively. The removal rate of Phenol (FIG. 5D) was 98.1%.

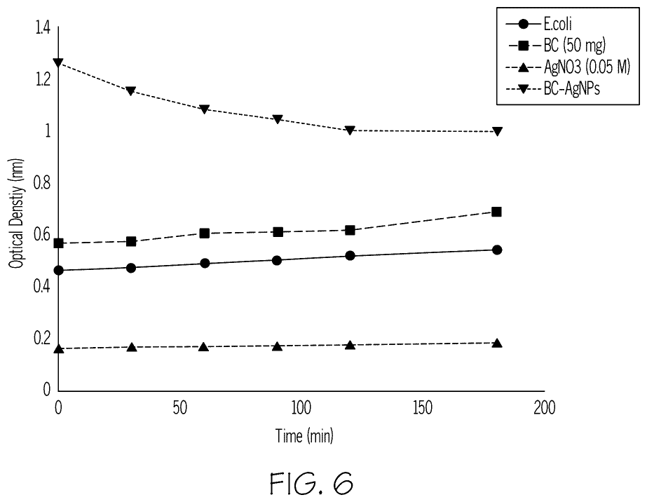

FIG. 6 provides data demonstrating the enhanced antibacterial activities of biochar-based AgNPs against E. coli. In particular, the bacterial suspension of E. coli was treated with biochar, silver nitrate, and a biochar-based nanocomposite, with each treatment being incubated separately at a temperature of 30-32° C. overnight. Bacterial cells scatter light in a suspension, causing turbidity which is measured as optical density (OD). The optical density (OD) of the samples was measured at 600 nm using a spectrophotometer to assess bacterial growth. Higher OD values indicate greater bacterial growth, while lower OD values suggest stronger antibacterial effects. The treated samples were compared to a control (untreated E. coli) to evaluate the impact of the nanocomposite on bacterial growth. As shown in FIG. 6, the nanocomposite initially exhibited a higher OD value at 0 minutes, but over time (120-150 minutes), the absorbance decreased, indicating antibacterial activity. In contrast, biochar showed a significant increase in OD, suggesting that biochar had no effect on bacterial growth. Similarly, a 0.05 M solution of silver nitrate (AgNO₃) showed minimal impact on the growth of E. coli.

### Example 1.2. Summary

In summary, the developed water filtration system in this Example is constructed using four layers, one on top of the other, with the following configuration from the uppermost layer to the lower layer: fine clays, functionalized biochar (FBC), a nanocomposite, and cotton balls. The four filtration layers are placed within a container with contaminated water entering the vessel from the top, passing through the clay layer, and the additional three layers via gravity, with the filtered water exiting the vessel at the bottom for collection and use. As depicted, the device filters dyes, pesticides, pathogens, organic contaminants, and other pollutants from wastewater.

The FBC is prepared using a biochar feedstock obtained from fruit and woody tree seed waste. A sample of the FBC using apricot and avocado fruit seed and woody tree seed waste was prepared, which, after collection, washing, and drying, was treated with 10-20% of mild acid for 6 hours, pyrolyzed in a furnace at 500° C. for two hours, then mortared and sieved. After characterizing the raw biomass and FBC via SEM, tests were performed to evaluate its ability to capture industrial dyes (e.g., crystal violet (CV) and methylene blue (MB)) and aromatic hydrocarbons (e.g., phenol). Tests were performed by adding CV and MB into separate flasks with the phenol. UV-Vis spectra analysis before and after dye adsorption indicated that after thirty minutes of adsorption, the CV and MB removal rates were 99.9% and 90.5%, respectively. The removal rate of phenol was 98.1%. After these tests, it was further demonstrated how silver nanoparticles can be embedded in the FBC by heat using a silver nitrate solution.

The proposed technology is a proof-of-concept four-layer filtration device utilizing biochar for water purification during emergencies and natural disasters (e.g., winter storms, floods, and/or earthquakes) and by the military when on remote maneuvers in extreme environmental conditions. Biochar as an environmentally preferred water treatment and membrane material has seen increased interest in recent years due to its availability, low price, high adsorption capability, potential to sequester heavy metals, pesticides, herbicides, hormones, and ability to prevent nitrate leaching and fecal bacteria from contaminating waterways. Initial validation tests showed that the FBC material created from Apricot/Avocado fruit seed waste and woody tree seed waste could successfully capture ˜99.9% of crystal violet, 90.5% of methylene blue dyes, and up to 98.1% of phenol from simulated contaminated water.

Without further elaboration, it is believed that one skilled in the art can, using the description herein, utilize the present disclosure to its fullest extent. The embodiments described herein are to be construed as illustrative and not as constraining the remainder of the disclosure in any way whatsoever. While the embodiments have been shown and described, many variations and modifications thereof can be made by one skilled in the art without departing from the spirit and teachings of the invention. Accordingly, the scope of protection is not limited by the description set out above, but is only limited by the claims, including all equivalents of the subject matter of the claims. The disclosures of all patents, patent applications and publications cited herein are hereby incorporated herein by reference, to the extent that they provide procedural or other details consistent with and supplementary to those set forth herein.

What is claimed is:

1. A composite material comprising:
a biochar; and
metal particles embedded with the biochar.

2. The composite of claim 1, wherein the biochar comprises an organic acid-treated and pyrolyzed biochar.

3. The composite of claim 1, wherein the biochar is derived from organic feedstock, wherein the organic feedstock is selected from the group consisting of plant-based feedstocks, agro-based feedstocks, vegetable-based feedstocks, fruit-based feedstocks, waste-based feedstocks, wood-based feedstocks, fruit pit, or combinations thereof.

4. The composite of claim 1, wherein the biochar is derived from fruit pit.

5. The composite of claim 1, wherein the metal particles comprise silver nanoparticles.

6. The composite of claim 1, wherein the composite material is a component of a liquid filtration unit, wherein the liquid filtration unit is in the form of a column.

7. The composite of claim 1, wherein the biochar comprises carboxylic acid groups on its surface, and wherein the metal particles are associated with the carboxylic acid groups.

8. The composite of claim 1, wherein the composite exhibits anti-bacterial properties.

9. A method of purifying a liquid, said method comprising:
applying the liquid to a composite material, wherein the composite material comprises:
a biochar; and
metal particles embedded with the biochar, wherein the composite material retains one or more impurities from the liquid.

10. The method of claim 9, further comprising a step of recovering the impurities from the composite material.

11. The method of claim 10, wherein the recovering comprises eluting the impurities from the composite material.

12. The method of claim 9, wherein the applying comprises filtration of the liquid through the composite material.

13. The method of claim 12, wherein the filtration comprises gravity based filtration without the utilization of pumps.

14. The method of claim 9, wherein the liquid comprises water.

15. The method of claim 9, wherein the impurities comprise pollutants selected from the group consisting of herbicides, hormones, organic pollutants, dyes, pathogenic organisms, agricultural materials, pesticides, pharmaceutical materials, hydrocarbons, inorganic contaminants, heavy metals, copper, lead, manganese, nickel, cobalt, or combinations thereof.

16. The method of claim 9, wherein the biochar comprises an organic acid-treated and pyrolyzed biochar.

17. The method of claim 9, wherein the biochar is derived from organic feedstock, wherein the organic feedstock is selected from the group consisting of plant-based feedstocks, agro-based feedstocks, vegetable-based feedstocks, fruit-based feedstocks, waste-based feedstocks, wood-based feedstocks, fruit pit, or combinations thereof.

18. The method of claim 9, wherein the biochar is derived from fruit pit.

19. The method of claim 9, wherein the metal particles comprise silver nanoparticles.

20. The method of claim 9, wherein the biochar comprises carboxylic acid groups on its surface, and wherein the metal particles are associated with the carboxylic acid groups.

21. A method of forming a composite material, said method comprising:
treating a biochar precursor with an acid;
pyrolyzing the biochar precursor to obtain biochar; and
mixing the biochar with metal particles.

22. The method of claim 21, wherein the biochar precursor comprises organic feedstock selected from the group consisting of plant-based feedstocks, agro-based feedstocks, vegetable-based feedstocks, fruit-based feedstocks, waste-based feedstocks, wood-based feedstocks, fruit pit, or combinations thereof.

23. The method of claim 21, wherein the biochar precursor comprises fruit pit.

24. The method of claim 21, wherein the pyrolysis occurs in the absence of air or oxygen at temperatures of at least 500° C.

25. The method of claim 21, wherein the mixing comprises stirring.

26. The method of claim 25, wherein the acid comprises an organic acid.

27. The method of claim 26, wherein the organic acid is selected from the group consisting of lactic acid, acetic acid, formic acid, citric acid, oxalic acid, uric acid, malic acid, tartaric acid, butyric acid, folic acid, or combinations thereof.

28. The method of claim 21, wherein the biochar comprises carboxylic acid groups on its surface, and wherein the metal particles are associated with the carboxylic acid groups.
